(19) United States
(12) Patent Application Publication
(10) Pub. No.: US 2021/0352484 A1
(43) Pub. Date: Nov. 11, 2021

(54) DETECTION AND MITIGATION OF MALICIOUS WIRELESS DEVICES

(71) Applicant: AT&T Intellectual Property I, L.P., Atlanta, GA (US)

(72) Inventors: Kartik Pandit, Aberdeen, NJ (US); Swapna Buccapatnam Tirumala, Holmdel, NJ (US)

(21) Appl. No.: 16/870,250

(22) Filed: May 8, 2020

(51) Int. Cl. H04W 12/12; H04W 12/00; H04W 12/08

(52) U.S. Cl. CPC H04W 12/1202; H04W 12/08; H04W 12/00514

(57) ABSTRACT

The present disclosure describes detection and mitigation of malicious wireless devices, in a wireless communication network including a radio access network (RAN) and a core network (CN), in a manner for selectively preventing the malicious wireless devices from using the wireless communication network based on identification of the malicious wireless devices in the wireless communication network. In one example, detection and mitigation of malicious wireless devices may include detecting a malicious wireless device based on identification of malicious activity by the malicious wireless device, identifying the malicious wireless device within the RAN based on correlation of one or more CN-based identifiers of the malicious wireless device within the CN and one or more RAN-based identifiers of the malicious wireless device within the RAN, and preventing the malicious wireless device from using the wireless communication network based on the one or more RAN-based identifiers of the malicious wireless device.

The present disclosure relates generally to wireless communication networks and, more particularly, to methods, non-transitory computer-readable media, and apparatuses for detection and mitigation of malicious wireless devices in wireless communication networks.

### BACKGROUND

Wireless communication networks may be subject to attacks initiated by malicious wireless devices. For example, wireless core networks, such as Evolved Packet Core (EPC) and Fifth Generation Core (5GC) networks, may be vulnerable to Distributed Denial of Service (DDoS) attacks in which User Equipments (UEs) can overload the EPC/5GC network elements with signaling messages. This can deny legitimate UEs from establishing data sessions and, further, can consume physical layer resources in the Radio Access Network (RAN) which can negatively impact the experience of legitimate UEs which are already connected.

### SUMMARY

In one example, the present disclosure describes methods, non-transitory computer-readable media, and apparatuses supporting detection and mitigation of malicious wireless devices in wireless communication networks.

In one example, a method is performed by a processing system including at least one processor. The method includes receiving, by the processing system, an indication of a request of a wireless device to access a service of a wireless communication network, wherein the wireless communication network includes a radio access network and a core network, wherein the wireless device is served by a wireless access device of the radio access network. The method includes obtaining, by the processing system based on the request to access the service of the wireless communication network, an indication of a malicious activity of the wireless device within the wireless communication network, wherein the indication of the malicious activity of the wireless device within the wireless communication network includes a core network based identifier of the wireless device, wherein the core network based identifier of the wireless device is configured to uniquely identify the wireless device within the core network. The method includes determining, by the processing system based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network. The method includes initiating, by the processing system based on the radio access network based identifier of the wireless device and the radio access network controller identifier of the radio access network controller, a mitigation action for mitigating the malicious activity of the wireless device within the wireless communication network.

In one example, a computer-readable medium stores instructions which, when executed by a processing system, cause the processing system to perform operations. The operations include receiving an indication of a request of a wireless device to access a service of a wireless communication network, wherein the wireless communication network includes a radio access network and a core network, wherein the wireless device is served by a wireless access device of the radio access network. The operations include obtaining, based on the request to access the service of the wireless communication network, an indication of a malicious activity of the wireless device within the wireless communication network, wherein the indication of the malicious activity of the wireless device within the wireless communication network includes a core network based identifier of the wireless device, wherein the core network based identifier of the wireless device is configured to uniquely identify the wireless device within the core network. The operations include determining, based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network. The operations include initiating, based on the radio access network based identifier of the wireless device and the radio access network controller identifier of the radio access network controller, a mitigation action for mitigating the malicious activity of the wireless device within the wireless communication network.

In one example, an apparatus includes a processing system including at least one processor and a computer-readable medium storing instructions which, when executed by the processing system, cause the processing system to perform operations. The operations include receiving an indication of a request of a wireless device to access a service of a wireless communication network, wherein the wireless communication network includes a radio access network and a core network, wherein the wireless device is served by a wireless access device of the radio access network. The operations include obtaining, based on the request to access the service of the wireless communication network, an indication of a malicious activity of the wireless device within the wireless communication network, wherein the indication of the malicious activity of the wireless device within the wireless communication network includes a core network based identifier of the wireless device, wherein the core network based identifier of the wireless device is configured to uniquely identify the wireless device within the core network. The operations include determining, based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network. The operations include initiating, based on the radio access network based identifier of the wireless device and the radio access network controller identifier of the radio access network controller, a mitigation action for mitigating the malicious activity of the wireless device within the wireless communication network.

In one example, a method is performed by a processing system including at least one processor. The method includes receiving, by the processing system, a request of a wireless device to access a wireless communication network, wherein the wireless communication network includes a radio access network and a core network. The method includes determining, by the processing system based on the request of the wireless device to access the wireless communication network, a radio access network based identifier of the wireless device, wherein the radio access network based identifier of the wireless device is configured to uniquely identify the wireless device within the radio access network. The method includes determining, by the processing system based on the radio access network based identifier of the wireless device and based on a blacklist of wireless devices to be blocked from accessing the radio access network, that the wireless device is to be blocked from accessing the radio access network, wherein the wireless device was previously added to the blacklist of wireless devices to be blocked from accessing the radio access network based on a determination that the wireless device engaged in malicious activity within the core network, identification of a core network based identifier of the wireless device based on the determination that the wireless device engaged in malicious activity within the core network, identification of the radio access network based identifier of the wireless device based on a mapping between the core network based identifier of the wireless device and the radio access network based identifier of the wireless device, and addition of the radio access network based identifier of the wireless device to the blacklist of wireless devices to be blocked from accessing the radio access network. The method includes initiating, by the processing system based on the determination that the wireless device is to be blocked from accessing the radio access network, a process for blocking the wireless device from accessing the radio access network.

In one example, a computer-readable medium stores instructions which, when executed by a processing system, cause the processing system to perform operations. The operations include receiving a request of a wireless device to access a wireless communication network, wherein the wireless communication network includes a radio access network and a core network. The operations include determining, based on the request of the wireless device to access the wireless communication network, a radio access network based identifier of the wireless device, wherein the radio access network based identifier of the wireless device is configured to uniquely identify the wireless device within the radio access network. The operations include determining, based on the radio access network based identifier of the wireless device and based on a blacklist of wireless devices to be blocked from accessing the radio access network, that the wireless device is to be blocked from accessing the radio access network, wherein the wireless device was previously added to the blacklist of wireless devices to be blocked from accessing the radio access network based on a determination that the wireless device engaged in malicious activity within the core network, identification of a core network based identifier of the wireless device based on the determination that the wireless device engaged in malicious activity within the core network, identification of the radio access network based identifier of the wireless device based on a mapping between the core network based identifier of the wireless device and the radio access network based identifier of the wireless device, and addition of the radio access network based identifier of the wireless device to the blacklist of wireless devices to be blocked from accessing the radio access network. The operations include initiating, based on the determination that the wireless device is to be blocked from accessing the radio access network, a process for blocking the wireless device from accessing the radio access network.

In one example, an apparatus includes a processing system including at least one processor and a computer-readable medium storing instructions which, when executed by the processing system, cause the processing system to perform operations. The operations include receiving a request of a wireless device to access a wireless communication network, wherein the wireless communication network includes a radio access network and a core network. The operations include determining, based on the request of the wireless device to access the wireless communication network, a radio access network based identifier of the wireless device, wherein the radio access network based identifier of the wireless device is configured to uniquely identify the wireless device within the radio access network. The operations include determining, based on the radio access network based identifier of the wireless device and based on a blacklist of wireless devices to be blocked from accessing the radio access network, that the wireless device is to be blocked from accessing the radio access network, wherein the wireless device was previously added to the blacklist of wireless devices to be blocked from accessing the radio access network based on a determination that the wireless device engaged in malicious activity within the core network, identification of a core network based identifier of the wireless device based on the determination that the wireless device engaged in malicious activity within the core network, identification of the radio access network based identifier of the wireless device based on a mapping between the core network based identifier of the wireless device and the radio access network based identifier of the wireless device, and addition of the radio access network based identifier of the wireless device to the blacklist of wireless devices to be blocked from accessing the radio access network. The operations include initiating, based on the determination that the wireless device is to be blocked from accessing the radio access network, a process for blocking the wireless device from accessing the radio access network.

### BRIEF DESCRIPTION OF THE DRAWINGS

The teachings of the present disclosure can be readily understood by considering the following detailed description in conjunction with the accompanying drawings, in which:

FIG. 1 illustrates an example system for supporting detection and mitigation of malicious wireless devices;

FIG. 2 illustrates a flowchart of an example method for supporting detection and mitigation of a malicious activity of a malicious wireless device;

FIG. 3 illustrates a flowchart of an example method for supporting blocking of a wireless device previously identified as a malicious wireless device; and

FIG. 4 illustrates a high level block diagram of a computing system specifically programmed to perform various steps, functions, blocks, and/or operations described herein.

To facilitate understanding, identical reference numerals have been used, where possible, to designate identical elements that are common to the figures.

### DETAILED DESCRIPTION

The present disclosure relates to methods, non-transitory computer-readable media, and apparatuses for detection and mitigation of malicious wireless devices in wireless communication networks.

In a wireless communication network supporting communications of wireless devices (e.g., User Equipments (UEs) or other types of wireless end devices), where the wireless communication network includes a wireless access network portion (e.g. a Radio Access Network (RAN)) and a wireless core network portion (e.g., a core network (CN)) supporting communications of wireless devices, the wireless communication network may be subject to various types of attacks which may be initiated by malicious wireless devices. For example, the CN may be subject to Distributed Denial of Service (DDoS) attacks in which malicious wireless devices may overload the network elements of the CN with signaling messages, thereby denying legitimate wireless devices from establishing data sessions and consuming physical layer resources in the wireless access network portion, both of which may negatively impact the experience that is provided to legitimate wireless devices of the wireless communication network. In one example, the wireless communication network may be configured to support detection and mitigation of such malicious wireless devices.

In one example, detection and mitigation of malicious wireless devices in a wireless communication network may include selectively preventing malicious wireless devices from using the wireless communication network based on identification of malicious wireless devices within the wireless communication network (e.g., based on identification of malicious activity, identification of the identities of malicious wireless devices engaging in malicious activity, and so forth). In one example, detection and mitigation of malicious wireless devices in a wireless communication network may include detecting a malicious wireless device based on identification of malicious activity by the malicious wireless devices using data from the CN, identifying the malicious wireless device within the RAN based on correlation of one or more CN-based identifiers of the malicious wireless device that uniquely identify the malicious wireless device within the CN (e.g., an International Mobile Subscriber Identity (IMSI) or other suitable identifiers or combination of identifiers) and one or more RAN-based identifiers of the malicious wireless device that uniquely identify the malicious wireless device within the RAN (e.g., a wireless device identifier of the wireless device within the RAN, a tuple of a wireless device identifier of the wireless device within the RAN and a mobility management identifier of the wireless device within the RAN, or other suitable identifiers or combinations of identifiers) within the RAN, and preventing the malicious wireless device from using the wireless communication network based on the one or more RAN-based identifiers of the malicious wireless device. In one example, detection and mitigation of malicious wireless devices in a wireless communication network may include detecting a malicious wireless device based on identification of malicious activity by the malicious wireless devices using data from the RAN, identifying the malicious wireless device within the RAN based on one or more RAN-based identifiers of the malicious wireless device that uniquely identify the malicious wireless device within the RAN (e.g., a wireless device identifier of the wireless device within the RAN, a tuple of a wireless device identifier of the wireless device within the RAN and a mobility management identifier of the wireless device within the RAN, or other suitable identifiers or combinations of identifiers), and preventing the malicious wireless device from using the wireless communication network based on the one or more RAN-based identifiers of the malicious wireless device. In this manner, malicious wireless devices may be preventing from using the wireless communication network (e.g., released from the RAN, blocked from accessing the RAN, and so forth) after being classified as malicious, thereby preventing malicious wireless devices from executing attacks (e.g., DDoS attacks or other types of attacks) against the CN and, thus, obviating the need to build and monitor individual attack protection mechanisms (e.g., DDoS attack prevention mechanisms) for each of the elements of the CN, conserving capacity in the RAN, improving experiences of legitimate wireless devices in the RAN, and so forth.

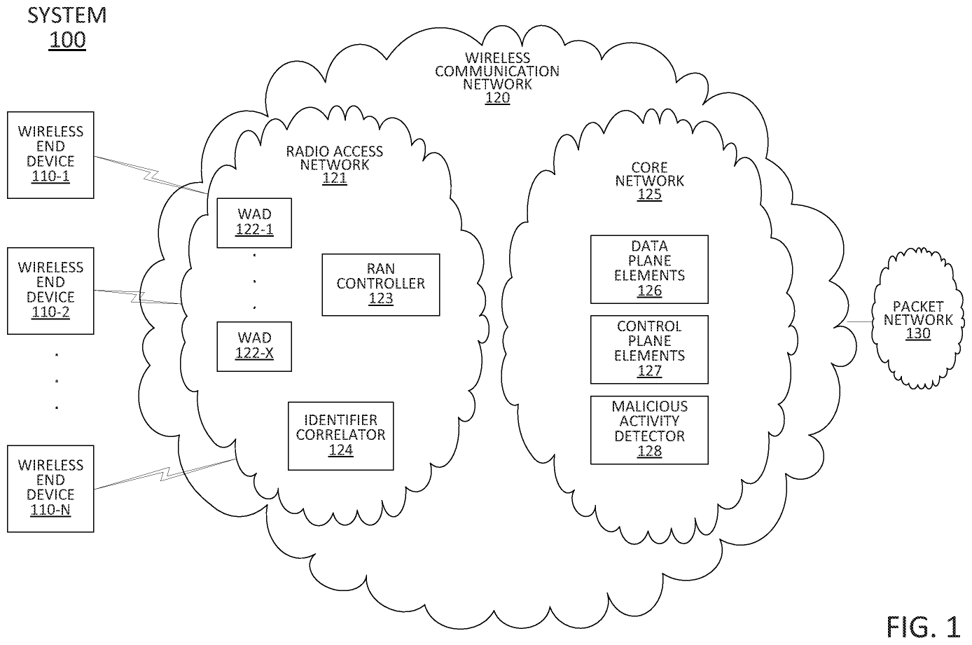

These and other aspects of the present disclosure are described in greater detail below in connection with the examples of FIGS. 1-4.

FIG. 1 illustrates an example system for supporting detection and mitigation of malicious wireless devices. In one example, the system 100 is configured to support detection and mitigation of malicious wireless devices. The system 100 includes a set of wireless endpoint devices (WEDs) 110-1-110-N (collectively, WEDs 110), a wireless communication network (WCN) 120, and a packet network (PN) 130. The WEDs 110 are configured to access the WCN 120 and communicate with the PN 130 via the WCN 120. The PN 130 may include any type of packet network which may be reached by the WEDs 110 via the WCN 120, such as one or more public networks (e.g., the Internet), one or more private networks (e.g., an enterprise network, a datacenter network, and the like), and so forth.

The WEDs 110 may include various types of communication devices which may wirelessly access the WCN 120 and communicate with the PN 130 via the WCN 120. In one example, the WEDs 110 may include mobile phones, cellular phones, smart phones, tablet computing devices, laptops, Internet-of-Things (IoT) devices, and the like. The WEDs 110 may be used for performing various services supported by WCN 120 and accessible from PN 130, such as voice call services, data services, texting services, multimedia streaming services, Internet access services, and the like. It will be appreciated that, for at least some wireless network releases and at least some device types, the WEDs 110 also may be referred to as User Equipments (UEs).

The WCN 120 may include any type of wireless communication network configured to support communications of the WEDs 110. In one example, the WCN 120 may include a Third Generation (3G) wireless network, a Fourth Generation (4G) wireless network, a Long Term Evolution (LTE) wireless network, a Fifth Generation (5G) wireless network, and the like. The WCN includes a radio access network (RAN) 121 (which also may be referred to herein as a wireless access network or wireless access network portion) and a core network (CN) 125 (which also may be referred to herein as a wireless core network or wireless core network portion). It will be appreciated that, although the WCN 120 may include various types of cellular technologies, the WCN 120 is primarily presented herein with respect to examples in which the WCN 120 includes 4G/LTE and/or 5G cellular technologies.

The RAN 121 is configured to support wireless communications of the WADs 110. The RAN 121 includes a set of wireless access devices (WADs) 122-1-122-X (collectively, WADs 122), a RAN controller 123, and an Identifier Correlator (IC) 124. It will be appreciated that the architecture of the RAN 121 (e.g., types of elements used, connectivity of the elements used, functionalities of the elements used, and the like) may depend on the network type of the WCN 120. For example, where the WCN 120 includes a 4G/LTE cellular network, the RAN 121 may include an Evolved-UMTS Terrestrial Radio Access Network (eUTRAN). For example, where the WCN 120 includes a 5G cellular network, the RAN 121 may include a Next-Generation-Radio Access Network (NG-RAN). It will be appreciated that the RAN 121 may be implemented based on various other types of cellular technologies. The RAN 121, as discussed further below, may be configured to perform various functions for supporting detection and mitigation of malicious WEDs 110 accessing the WCN 120 via the WADs 122.

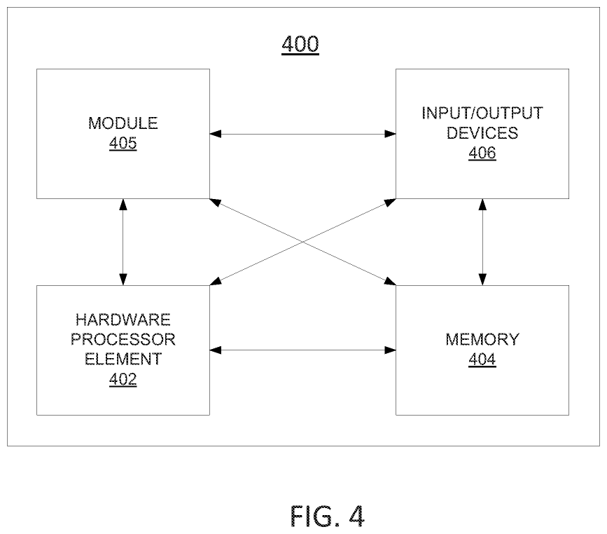

The WADs 122 are configured to provide wireless connectivity to the WEDs 110. It will be appreciated that the WADs 122 may include various types of devices, which may depend on the network type of the WCN 120. For example, where the WCN 120 includes a 4G/LTE cellular network and the RAN 121 is an eUTRAN, the WADs 122 may be evolved NodeBs (eNBs). For example, where the WCN 120 includes a 5G cellular network and the RAN 121 is an NG-RAN, the WADs 122 may be next-generation NodeBs (gNBs). It will be appreciated that various other types of devices may be used as WADs 122. The WADs 122, as discussed further below, may be configured to perform various functions for supporting detection and mitigation of malicious WEDs 110 accessing the WCN 120 via the WADs 122. In one example, a WAD 122 includes a computing device or processing system, such as the computing system 400 depicted in FIG. 4, and, thus, may be configured to provide one or more operations or functions for supporting detection and mitigation of malicious activity of malicious wireless devices as discussed herein.

The RAN controller 123 is configured to provide control functions within the RAN 121. The RAN controller 123 may be configured to perform various functions for supporting detection and mitigation of malicious WEDs 110 accessing the WCN 120 via the WADs 122. The RAN controller 123 may be configured to identify malicious WEDs 110 and to initiate mitigation actions for mitigating the malicious activity of the malicious WEDs 110. The RAN controller 123 may be configured to identify malicious WEDs 110 within the RAN 121 based on signaling from within the RAN 121 (e.g., based on information from WADs 122 or other elements of the RAN 121 which may be configured to detect malicious activity of malicious WEDs 110), based on signaling from the CN 125 (e.g., based on detection of malicious WEDs 110 by elements of the CN 125), and the like. The RAN controller 123 may be configured to identify malicious WEDs 110 within the RAN 121 based on interaction with the IC 124 (e.g., where signaling from the CN 125 includes a CN-based identifier of a malicious WED 110 and the RAN controller 123 queries the IC 124 based on the CN-based identifier of the malicious WED 110 to obtain the RAN-based identifier of the malicious WED 110). The RAN controller 123 may be configured to initiate mitigation actions, for mitigating malicious activity of malicious WEDs 110, which may include releasing malicious WEDs 110 from the RAN 121, blocking malicious WEDs 110 from accessing the RAN 121, and the like. It will be appreciated that the RAN controller 123 may be implemented in various ways, which may depend on the network type of the WCN 120. For example, where the WCN 120 includes a 4G/LTE cellular network and the RAN 121 is an eUTRAN, the RAN controller 123 may be implemented as a standalone controller within the RAN 121. For example, where the WCN 120 includes a 5G cellular network and the RAN 121 is an NG-RAN, the RAN controller 123 may be implemented as a Radio Intelligent Controller (RIC) or as a portion of a RIC (e.g., an xApp configured to run on a RIC). It will be appreciated that the RAN controller 123 may be implemented within the RAN 121 in various other ways. The RAN controller 123 may be configured to perform various other functions for supporting detection and mitigation of malicious WEDs 110 accessing the WCN 120. In one example, the RAN controller 123 includes a computing device or processing system, such as the computing system 400 depicted in FIG. 4, and, thus, may be configured to provide one or more operations or functions for supporting detection and mitigation of malicious activity of malicious wireless devices as discussed herein.

The IC 124 is configured to support use of identifier mappings to support detection and mitigation of malicious WEDs 110. The IC 124 may be configured to maintain mappings between RAN-based identifiers of WEDs 110 and CN-based identifiers of WEDs 110. The IC 124 may be configured to maintain mappings between CN-based identifiers of WEDs 110 and RAN-based information of the WEDs 110 which may include the RAN-based identifiers of WEDs 110 and the RAN controller identifiers of the RAN controllers with which the WEDs 110 are associated (e.g., RAN controller 123 controlling the WADs 122, or other RAN controllers (omitted for purposes of clarity) which may be used to control the WADs 122 with which the WEDs 110 are associated). The IC 124 may be configured to respond to requests for RAN-based information of WEDs 110 (e.g., RAN-based identifiers of WEDs 110, RAN controller identifiers of RAN controllers controlling WADs 122 with which the WEDs 110 are associated, and so forth) based on CN-based identifiers of WEDs 110 within the context of detection and mitigation of malicious WEDs 110. The IC 124 may be configured to continuously update the CN-to-RAN mapping information of the WEDs 110 as it changes (e.g., based on information from elements of the RAN 121, such as WADs 122 and RAN controllers such as RAN controller 123, and from elements of the CN 125). It will be appreciated that, although primarily presented herein with respect to examples in which the IC 124 is deployed within the RAN 121, the IC 124 also may be deployed within the CN 125. In one example, the IC 124 includes a computing device or processing system, such as computing system 400 depicted in FIG. 4, and, thus, may be configured to provide one or more operations or functions for supporting detection and mitigation of malicious activity of malicious wireless devices as discussed herein.

The CN 125 is configured to support communications of the WEDs 110. The CN 125 includes data plane elements 126, control plane elements 127, and a malicious activity detector (MAD) 128. The data plane elements 126 are configured to provide data plane functionality supporting communications of the WEDs 110 and the control plane elements 127 are configured to provide control plane functionality supporting communications of the WEDs 110. It will be appreciated that various functions supported by the CN 125 may be distributed across the data plane elements 126 and the control plane elements 127 in various ways (e.g. the arrangement and distribution of the functions may vary for different types of cellular technology which may be used to provide the CN 125). The MAD 128 may be configured to support detection and mitigation of malicious WEDs 110. It will be appreciated that the architecture of the CN 125 may depend on the network type of the wireless communication network.

In one example, where the WCN 120 includes a 4G/LTE cellular network, the CN 125 may be an Evolved Packet Core (EPC). In one example, where the CN 125 is an EPC, the data plane elements 126 may include a Serving Gateway (SGW) and a Packet Data Network (PDN) Gateway (PGW) and the control plane elements 127 may include a Mobility Management Entity (MME). It will be appreciated that the CN 125 may include various other types of data plane elements 126 and/or control plane elements 127.

In one example, where the WCN 120 includes a 5G cellular network, the CN 125 may be a 5G Core (5GC). In one example, where the CN 125 is a 5GC, the data plane elements 126 may include a User Packet Function (UPF) and the control plane elements 127 may include an Access and Mobility Management Function (AMF) and a Session Management Function (SMF). It will be appreciated that the CN 125 may include various other types of data plane elements 126 and/or control plane elements 127.

The data plane elements 126 may be configured to provide data plane functionality supporting communications of the WEDs 110. For example, the data plane elements 126 may be configured to support mobility anchoring, address allocation (e.g., allocation of Internet Protocol (IP) addresses or other types of addresses), packet forwarding, packet filtering, and the like. It will be appreciated that the data plane elements 126 may be configured to provide various other types of data plane functionality supporting communications of the WEDs 110 in the CN 125.

The control plane elements 127 may be configured to provide control plane functionality supporting communications of the WEDs 110. For example, the control plane elements 127 may be configured to support mobility handling, address allocation, bearer handling, session handling, and the like. It will be appreciated that the control plane elements 127 may be configured to provide various other types of control plane functionality supporting communications of the WEDs 110 in the CN 125.

The MAD 128 may be configured to support detection and mitigation of malicious WEDs 110. The MAD 128 may be configured to support detection of malicious activity of malicious WEDs 110 within the CN 125 based on analysis of various types of data available within the WEDs 110 (e.g., call detail records (CDRs), key performance indicators (KPIs), and so forth). The MAD 128 may be configured to support determination of a RAN-based identity of a malicious WED 110 (e.g., the MAD 128 may determine the RAN-based identity of the malicious WED 110 by requesting a RAN-based identifier of the malicious WED 110 from the IC 124 based on a CN-based identifier of the malicious WED 110 provided to the IC 124 by the MAD 128, the MAD 128 may enable the RAN controller 123 to determine the RAN-based identity of the malicious WED 110 by provide the CN-based identifier of the malicious WED 110 to the RAN controller 123 for use by the RAN controller 123 to request a RAN-based identifier of the malicious WED 110 from the IC 124 based on a CN-based identifier of the malicious WED 110, and so forth). The MAD 128 may be configured to initiate mitigation of the malicious WED 110 (e.g., providing an indication of an identity of the malicious WED 110 to the RAN controller 123, by providing either the RAN-based identifier of the malicious WED 110 or the CN-based identifier of the malicious WED 110 to the RAN controller 123, for use by the RAN controller 123 in initiating a mitigation action for causing the malicious WED 110 to be released from the RAN 121 and, possibly, to be blocked from accessing the RAN 121 in the future). It will be appreciated that the MAD 128 may be configured to support various other functions for supporting detection and mitigation of malicious WEDs 110. It will be appreciated that, although presented herein as a standalone element, the MAD 128 may be implemented as part of one or more of the data plane elements 126, one or more of the control plane elements 127, a combination of one or more data plane elements 126 and one or more control plane elements 127, or the like. In one example, a MAD 128 includes a computing device or processing system, such as computing system 400 depicted in FIG. 4, and, thus, may be configured to provide one or more operations or functions for supporting detection and mitigation of malicious activity of malicious wireless devices as discussed herein.

It will be appreciated that the WNC 120, including the RAN 121 and the CN 125, may include various other types of networks, functions, elements, and the like.

The WCN 120 is configured to support detection and mitigation of malicious activity in the WCN 120. The WCN 120 may be configured to support detection and mitigation of malicious activity that may be initiated by one or more of the WEDs 110 which access the WCN 120. The detection and mitigation of malicious activity that may be initiated by WEDs 110 which access the WCN 120 may be initiated based on requests by the WEDs 110 to access services of the WCNs 120 (e.g., based on requests of WEDs 110 to attach to the RAN 121, based on requests of the WEDs 110 to maintain connections to the RAN 121, based on requests of the WEDs 110 to use resources or services of the RAN 121, based on requests of the WEDs 110 to use resources or services of the CN 125, and the like). The detection and mitigation of malicious activity may include detecting malicious activity, identifying a WED 110 which initiated the malicious activity, and initiating a mitigation action for mitigating the malicious activity initiated by the WED 110. The malicious activity may be detected in the CN 125 and/or may be detected in the RAN 121. The WED 110 which initiated the malicious activity may be identified based on correlation of various identifiers associated with the WED 110 (e.g., where correlation of various identifiers associated with the WED 110 may be determined and maintained by the IC 124 for use in identifying malicious WEDs 110 within the RAN 121 based on RAN-based identifiers of the malicious WEDs 110). The WED 110 which initiated the malicious activity may be identified within the CN 125 (e.g., identified by the MAD 128 based on interaction with the IC 124) and signaled to the RAN 121 for use within the RAN 121 to control mitigation of the malicious activity executed by the WED 110 or may be identified within the RAN 121 (e.g., identified by the RAN controller 123 based on interaction with the IC 124) for use within the RAN 121 to control mitigation of the malicious activity executed by the WED 110. The mitigation action for mitigating the malicious activity executed by the WED 110 may be performed within the RAN 121 and may include mitigation actions such as releasing the WED 110 which initiated the malicious activity such that the WED 110 loses connectivity with the RAN 121, blocking the WED 110 which initiated the malicious activity such that the WED 110 cannot establish connectivity with the RAN 121, and the like. It will be appreciated that the WCN 120 may be configured to support various other functions to support detection and mitigation of malicious activity in the WCN 120.

The detection and mitigation of malicious activity in the WCN 120 may be based on determining and maintaining correlations between various identifiers associated with the WEDs 110 (e.g., RAN-based identifiers configured to uniquely identify the WEDs 110 within the RAN 121 and CN-based identifiers configured to uniquely identify the WEDs 110 within the CN 125). The various identifiers associated with the WED 110 may be correlated based on various mechanisms for correlating the various identifiers associated with the WED 110.

The RAN controller 123 may receive the RAN-based identifier of the WED 110 when the WED 110 attaches to one of the WADs 122 and provide the RAN-based identifier of the WED 110 to the IC 124. In one example, the RAN-based identifier of the WED 110 is a wireless device identifier of the WED 110 that uniquely identifies the WED 110 within the RAN 121. In one example, the RAN-based identifier of the WED 110 is a tuple, including a wireless device identifier of the WED 110 within the RAN 121 and a mobility management identifier assigned to the WED 110 by a mobility management device within the CN 125 (e.g., an MME in a 4G/LTE network, an AMF in a 5G network), that uniquely identifies the WED 110 within the RAN 121. For example, where the WCN 120 is a 4G/LTE network, the RAN-based identifier of the WED 110 may include a tuple including a User Equipment (UE) S1 Application Protocol (S1-AP) ID and an MME S1-AP ID, which may be obtained by the RAN controller 123 based on interaction between the WED 110 and an MME of the CN 125 when the WED 110 attaches to the one of the WADs 122 (e.g., the WED 110 is assigned a UE S1-AP ID when it attaches to the WAD 122, the WAD 122 sends the UE S1-AP ID of the WED 110 to the MME of the CN 125, the MME of the CN 125 responds to the WAD 122 with the MME S1-AP ID of the WED 110, and the WAD 122 provides the UE S1-AP ID and the MME S1-AP ID of the WED 110 to the RAN controller 123). For example, where the WCN 120 is a 5G network, the RAN-based identifier of the WED 110 may include a tuple including a UE S1-AP ID and an MME S1-AP ID, which may be obtained by RAN controller 123 based on interaction between the WED 110 and an AMF of the CN 125 when the WED 110 attaches to the one of the WADs 122 (e.g., the WED 110 is assigned a UE S1-AP ID when it attaches to the WAD 122, the WAD 122 sends the UE S1-AP ID of the WED 110 to the AMF of the CN 125, the AMF of the CN 125 responds to the WAD 122 with the MME S1-AP ID of the WED 110, and the WAD 122 provides the UE S1-AP ID and the MME S1-AP ID of the WED 110 to the RAN controller 123). It will be appreciated that, although primarily described with respect to use of specific RAN-based identifiers to identify the WED 110 within the RAN 121, various other RAN-based identifiers may be used to identify the WED 110 within the RAN 121 (e.g., in 4G/LT networks, 5G networks, other types of cellular networks, and so forth). The RAN controller 123 also provides its own identifier to the IC 124 (e.g., a RAN controller identifier in a 4G/LTE network, a RIC identifier in a 5G network, and so forth) when providing the RAN-based identifier of the WED 110 to the IC 124, such that the IC 124 may maintain a mapping of the RAN-based identifier of the WED 110 to the RAN controller identifier of the RAN controller 123 that controls the WAD 122 with which the WED 110 is associated.

The IC 124 determines the CN-based identifier of the WED 110 based on interaction with one or more elements of the CN 125. In one example, the CN-based identifier of the WED 110 is a subscriber identity of the WED 110 (e.g., an IMSI). For example, where the WCN 120 is a 4G/LTE network, the CN-based identifier of the WED 110 may be an IMSI since the elements of the CN 125 operate within the IMSI namespace and data of the CN 125 which includes IMSI information (e.g., CDRs, session logs, flows data, and the like) may be used to identify malicious WEDs 110. For example, where the WCN 120 is a 5G network, the CN-based identifier of the WED 110 may be an IMSI since the elements of the CN 125 operate within the IMSI namespace and data of the CN 125 which includes IMSI information (e.g., CDRs, session logs, flows data, and the like) may be used to identify malicious WEDs 110. It will be appreciated that, although primarily described with respect to use of specific CN-based identifiers to identify the WED 110 within the CN 125, various other CN-based identifiers may be used to identify the WED 110 within the CN 125 (e.g., in 4G/LT networks, 5G networks, other types of cellular networks, and so forth).

The IC 124 determines and maintains a mapping between the CN-based identifier of the WED 110 and the RAN-based identifier of the WED 110 and the RAN controller identifier of the RAN controller 123 controlling the WAD 122 that is serving the WED 110. For example, where the WCN 120 is a 4G/LTE network, the IC 124 may determine the mapping between the CN-based identifier of the WED 110 (e.g., the IMSI) and the RAN-based identifier of the WED 110 (e.g., the tuple including the UE S1-AP ID and the MME S1-AP ID) based on records from the MME in the CN 125 (e.g., Cell Trace UE-ID Mapping (CTUM) records or other suitable types of records). For example, where the WCN 120 is a 5G network, the IC 124 may determine the mapping between the CN-based identifier of the WED 110 (e.g., the IMSI) and the RAN-based identifier of the WED 110 (e.g., the tuple including the UE S1-AP ID and the MME S1-AP ID) based on records from the AMF in the CN 125 (e.g., cell trace mapping records or other suitable types of records). It will be appreciated that, although primarily described with respect to use of specific records to determine the mapping between the CN-based identifier of the WED 110 and the RAN-based identifier of the WED 110, various other records, which may be obtained from the same sources and/or one or more other sources, may be used to determine the mapping between the CN-based identifier of the WED 110 and the RAN-based identifier of the WED 110 (e.g., in 4G/LT networks, 5G networks, other types of cellular networks, and so forth).

The RAN controller 123 updates the IC 124 with the latest RAN-based identifiers of WEDs 110. It will be appreciated that the RAN-based identifiers active within the RAN 121 may change as new WEDs 110 attach to the RAN 121, as existing WEDs 110 roam between WADs 122 of the RAN 121, as existing WEDs 110 leave the RAN 121, and so forth. It will be appreciated that such changes also may result in changes to the RAN controller identifiers associated with WEDs 110 (e.g., as WEDs 110 move between regions managed by different RAN controllers such as RAN controller 123, as new RAN controllers are instantiated and existing RAN controllers are terminated, and the like). It will be appreciated that such changes also may result in changes to the CN-based identifiers of the CN 125 associated with WEDs 110. The IC 124 updates the mappings between the CN-based identifiers of the WEDs 110 and the RAN-based identifiers of the WEDs 110 and the RAN controller identifiers of the RAN controllers associated with the WADs 122 supporting the WEDs 110, thereby maintaining fresh looks into both the RAN 121 and the CN 125 for supporting selective mitigation of malicious attacks against the WCN 120.

It will be appreciated that, although primarily presented herein with respect to examples in which the IC 124 determines and maintains mappings between specific identifiers, the IC 124 may determine and maintain mappings between various other identifiers which may be used for detection and mitigation of malicious activity of WEDs 110 in the WCN 120.

It will be appreciated that, although primarily presented herein with respect to examples in which the RAN controller 123 and the IC 124 are separate elements, in at least some examples the RAN controller 123 and the IC 124 may be implemented as a combined element (e.g., the functionality of the IC 124 may be incorporated within the RAN controller 123).

The detection and mitigation of malicious activity in the WCN 120 may be based on detection of malicious activity of WEDs 110 within the CN 125. The detection of malicious activity of WEDs 110 within the CN 125 may be performed by the MAD 128. The detection of malicious activity of WEDs 110 within the CN 125 may be based on visibility into application types, service types, Access Point Name (APN) types, and the like. The detection of malicious activity of WEDs 110 within the CN 125 may be based on detection of various types of conditions which may be indicative of malicious activity (e.g., conditions related to connection attempts of WEDs 110, conditions related to messages sent via connections established by WEDs 110, conditions related to termination of connections by WEDs 110, and the like). The detection of malicious activity of WEDs 110 within the CN 125 may be based on analysis of various types of data which may be available within the CN 125 (e.g., CDRs, KPIs, and the like). It will be appreciated that at least some such mechanisms for detecting malicious activity of WEDs 110 may be useful to detect security attacks that are masked as noise in PDU counts such that PDU counts are not suitable for detection of such security attacks.

In one example, detection of malicious activity of WEDs 110 within the CN 125 may be based on detection of various types of conditions which may be indicative of malicious activity. For example, detection of malicious activity of WEDs 110 within the CN 125 may be based on a volume of connection attempts exceeding a threshold, a volume of data sent exceeding a threshold, one or more messages having zero bytes in the data field, an indication of termination of a connection after establishment of the connection (e.g., for E911 calls or other types of connections), an indication of repeated establishment and termination of bearer sessions without any data bytes being sent, and the like. It will be appreciated that various other conditions may be used as the basis for detection, within the CN 125, of malicious activity of WEDs 110. It will be appreciated that such conditions may be detected within the CN 125 by the MAD 128.

In one example, detection of malicious activity of WEDs 110 within the CN 125 may be based on analysis of CDRs in the CN 125. The MAD 128 may access CDRs available from elements of the CN 125 (e.g., a PGW in a 4G/LTE network, a UPF in a 5G network, and the like), may be implemented as part of one or more elements of the CN 125 having visibility into the application/service/APN types of the CN 125 so as to be able to access CDRs locally, or the like. The detection of malicious activity of WEDs 110 within the CN 125 based on analysis of CDRs may be based on detection, within the CDRs, of anomalies indicative of malicious activities of WEDs 110. For example, analysis of CDRs may result in detection of attacks such as E911 attacks, coordinated data downloads, and the like. The MAD 128 may continuously monitor CDRs for detection of malicious activity of WEDs 110.

In one example, detection of malicious activity of WEDs 110 within the CN 125 may be based on analysis of KPIs in the CN 125. The MAD 128 may access KPIs available from various elements of the CN 125 and analyze the KPIs to detect malicious activities of WEDs 110. For example, the MAD 128 may detect a signaling overload storm based on analysis of KPIs available in the CN 125. The KPIs that are collected and analyzed may be KPIs of a single element of the CN 125 (e.g., an MME, SGW, or PGW in a 4G/LTE network, a UPF, AMF, or SMF in a 5G network, or the like) in order to detect an overload of that element of the CN 125 based on a signaling overload storm. For example, in the case of a signaling overload storm initiated against an MME in the CN 125, the KPIs which may be analyzed to detect a signaling overload storm may include MME KPIs such as S11 packet in and out usage data; PAS CCR-I and CCR-T counts, and the like. The KPIs that are collected and analyzed may be KPIs of a combination of elements of the CN 125 in order to detect a signaling overload storm that is based on multiple elements of the CN 125. The MAD 128 may continuously monitor KPIs for detection of malicious activity of WEDs 110.

It will be appreciated that detection of malicious activity of WEDs 110 within the CN 125 may be performed in various other ways.

The detection and mitigation of malicious activity in the WCN 120, where the malicious activity of a malicious WED 110 is detected within the CN 125, may be based on identification of the RAN-based identity of the malicious WED 110 (e.g., the RAN-based identifier of malicious WED 110) within the CN 125 and signaling of an indication of the RAN-based identifier of the malicious WED 110 to the RAN 121 for use within the RAN 121 to control mitigation of the malicious activity of the malicious WED 110. In one example, the MAD 128 may identify the RAN-based identifier of the malicious WED 110 associated with the malicious activity based on interaction with the IC 124 and signal an indication of the RAN-based identifier of the malicious WED 110 associated with the malicious activity to the RAN controller 123 in the RAN 121. The MAD 128 may identify the RAN-based identifier of the malicious WED 110 associated with the malicious activity, based on interaction with the IC 124, by querying IC 124 based on the IMSI of the malicious WED 110, which is determined based on detection of the malicious activity of the malicious WED 110, to obtain the RAN-based identifier of the malicious WED 110 and the RAN controller identifier associated with the RAN-based identifier of the malicious WED 110. The IC 124, based on the query from the MAD 128 that includes the IMSI of the malicious WED 110, uses the IMSI of the malicious WED 110 to retrieve the RAN-based identifier of the malicious WED 110 and the RAN controller identifier associated with the RAN-based identifier of the malicious WED 110, which are then returned from the IC 124 to the MAD 128. The MAD 128 then signals the RAN-based identity of the malicious WED 110 (e.g., the RAN-based identifier of the malicious WED 110) to the RAN controller 123 based on the RAN controller identifier of the RAN controller 123. The MAD 128 may signal the indication of the malicious WED 110 to the RAN 121, for use within the RAN 121 to control mitigation of the malicious activity of the malicious WED 110, in various ways (e.g., individually or as part of a list of offending WEDs 110, using various interfaces, using various message types, and the like). For example, the MAD 128 may signal the indication of the malicious WED 110 to the RAN 121 using an A1/O1 interface in 5G networks or other suitable interfaces available in other types of wireless communication networks. In this manner, the RAN controller 123 that controls the WAD 122 with which the malicious WED 110 is associated learns the RAN-based identity of the malicious WED 110, which may be used by the RAN controller 123 to initiate mitigation of the malicious activity by the malicious WED 110.

The detection and mitigation of malicious activity in the WCN 120, where the malicious activity of a malicious WED 110 is detected within the CN 125, may be based on identification of the RAN-based identity of the malicious WED 110 (e.g., the RAN-based identifier of malicious WED 110) within the RAN 121 for use within the RAN 121 to control mitigation of the malicious activity of the malicious WED 110. In one example, the RAN controller 123 may receive an indication of the IMSI of the malicious WED 110 from the MAD 128 (e.g., based on detection of the malicious activity of the malicious WED 110 by the MAD 128) and identify the RAN-based identifier of the malicious WED 110 associated with the malicious activity based on interaction with the IC 124. The indication of the IMSI of the malicious WED 110 may be received by the RAN controller 123 from the MAD 128 in various ways (e.g., using various interfaces, message types, protocols, and the like). The RAN controller 123 may identify the RAN-based identifier of the malicious WED 110 associated with the malicious activity, based on interaction with the IC 124, by querying IC 124 based on the IMSI of the malicious WED 110, received from the MAD 128, to obtain the RAN-based identifier of the malicious WED 110. The IC 124, based on the query from the RAN controller 123 that includes the IMSI of the malicious WED 110, uses the IMSI of the malicious WED 110 to retrieve the RAN-based identifier of the malicious WED 110, which is then returned from the IC 124 to the RAN controller 123. In this manner, the RAN controller 123 that controls the WAD 122 with which the malicious WED 110 is associated learns the RAN-based identity of the malicious WED 110, which may be used by the RAN controller 123 to initiate mitigation of the malicious activity by the malicious WED 110.

The detection and mitigation of malicious activity in the WCN 120 may be based on detection of malicious activity of WEDs 110 within the RAN 121. The detection of malicious activity of WEDs 110 within the RAN 121 may be based on analysis of PDU counts of the WEDs 110. The detection of malicious activity of WEDs 110 within the RAN 121 based on analysis of PDU counts of the WEDs 110 may be based on anomaly/outlier detection on PDU counts of the WEDs 110. In one example, detection of an anomaly or outlier in the PDU counts of the WED 110 may be performed by building a baseline of PDU counts of the WED 110 (e.g., building a baseline that is associated with the RAN-based identifier of the WED 110) and monitoring the PDU counts of the WED 110 for the occurrence of an anomaly (e.g., a determination that the PDU count of the WED 110 exceeds the baseline by a threshold amount). In one example, the PDU counts of the WED 110 may be obtained from the WAD 122 to which the WED 110 is connected. The WADs 122 may be configured to maintain various types of PDU count statistics for individual WEDs 110 (e.g., aggregate PDU counts across WEDs 110 as a function of time, running averages of PDU counts, and the like) and provide the PDU count statistics for the WEDs 110 to the RAN controller 123 for use in anomaly/outlier detection. In one example, detection of an anomaly or outlier in the PDU counts of the WED 110 may be performed by a PDU anomaly detector (e.g., which may be provided as part of the RAN controller 123 or which may be provided as a standalone element in communication with the RAN controller 123), which may receive PDU counts from the WADs 122 for each unique RAN-based identifier associated with the WADs 122, build baseline PDU counts for each unique RAN-based identifier associated with the WADs 122, and detect malicious activity associated with RAN-based identifiers based on the baseline PDU counts associated with the RAN-based identifiers and updated PDU counts received from the WADs 122 for the RAN-based identifiers. In this manner, the RAN controller 123 learns the identity of the malicious WED 110, which may be used by the RAN controller 123 to initiate mitigation of the malicious activity by the malicious WED 110.

The mitigation of malicious activity in the WCN 120 may be performed by initiating a mitigation action. The mitigation action may include releasing the malicious WED 110 from the WCN 120, blocking the malicious WED 110 from accessing the WCN 120, or the like.

In one example, the mitigation action may include releasing the malicious WED 110 from the WCN 120. In one example, releasing the malicious WED 110 from the WCN 120 may include one or more actions configured to cause the malicious WED 110 to lose its connection with the RAN 121. In one example, the one or more actions configured to cause the malicious WED 110 to lose its connection with the RAN 121 may include initiating a RAN release procedure for the RAN-based identifier of the malicious WED 110. For example, in a 4G/LTE network, an RRC connection release procedure (or other suitable connection release procedure) supported by the RAN 121 may be initiated for causing the malicious WED 110 to be released from the RAN 121. For example, in a 5G network, a Secondary Node (SgNB) release (or other suitable release procedure) supported by the RAN 121 may be initiated for causing the malicious WED 110 to be released from the RAN 121 (e.g., based on an instruction from the RIC to the gNB serving the malicious WED 110 on the E2 interface, based on an instruction from the RIC to a management system of the gNB serving the malicious WED 110, or the like). In one example, the one or more actions configured to cause the malicious WED 110 to lose its connection with the RAN 121 may include reallocating the physical resources (e.g., physical resource blocks (PRBs) or other physical resources) used by the malicious WED 110, or the like. It will be appreciated that various other mechanisms may be used to cause the release of the malicious WED 110 from the WCN 120.

In one example, the mitigation action may include blocking the malicious WED 110 from accessing the WCN 120. In one example, blocking the malicious WED 110 from the WCN 120 may include adding the malicious WED 110 to a blacklist of WEDs 110 which are not permitted to access the WCN 120. In one example, blocking the malicious WED 110 from the WCN 120 may include rejecting a request by the malicious WED 110 to access the RAN 121 (e.g., blocking an RRC connection request, blocking a Non-access stratum (NAS) attach request, or the like). It will be appreciated that various other mechanisms may be used to block the malicious WED 110 from accessing the WCN 120.

It will be appreciated that mitigation of malicious activity in the WCN 120 may be performed by initiating various other types of mitigation actions configured to prevent WEDs 110 from accessing and using the WCN 120. It will be appreciated that the mitigation action may be initiated in various ways which may depend on the manner in which detection of the malicious activity being mitigated is performed.

In one example, where the identification of the malicious WED 110 is performed within the CN 125, for use within the RAN 121 to control mitigation of the malicious activity of the malicious WED 110, the MAD 128 (or other suitable elements) may initiate the mitigation action by sending a message to the RAN controller 123 associated with the malicious WED 110 for causing the RAN controller 123 associated with the malicious WED 110 to initiate a release of the malicious WED 110 from the WCN. The message may include an indication that the malicious WED 110 has engaged in malicious (or potentially malicious) activity, the RAN-based identifier of the malicious WED 110 to enable identification of the malicious WED 110 within the RAN 121, and the RAN controller identifier of the RAN controller 123 (used to direct the message to the RAN controller 123, which has been determined by the MAD 128 to be the control element for the WAD 122 to which the malicious WED 110 is connected). It will be appreciated that, here, the RAN controller 123 also may be considered to initiate a mitigation action based on the message from the MAD 128, since the message from the MAD 128 will trigger the RAN controller 123 to initiate a mitigation action to mitigate the malicious activity of the malicious WED 110 (e.g., sending one or more messages to the WAD 122 to which the malicious WED 110 is connected, sending one or more messages to a management system configured to manage the WAD 122 to which the malicious WED 110 is connected, and the like).

In one example, where the identification of the malicious WED 110 is performed within the RAN 121, for use within the RAN 121 to control mitigation of the malicious activity of the malicious WED 110, the RAN controller 123 may initiate the mitigation action by sending one or more messages to the WAD 122 to which the malicious WED 110 is connected, sending one or more messages to a management system configured to manage the WAD 122 to which the malicious WED 110 is connected, and the like.

In various examples above, the RAN controller 123 ultimately determines the RAN-based identity of a malicious WED 110 and may initiate a mitigation action to mitigate the malicious activity of the malicious WED 110 based on the RAN-based identity of the malicious WED 110. In one example, the RAN controller 123 may initiate the mitigation action by sending a message to the WAD 122 to which the malicious WED 110 is connected (e.g., a message configured to trigger the WAD 122 to cause the malicious WED 110 to lose its connection with the RAN 121, a message configured to trigger the WAD 122 to prevent the malicious WAD 122 from accessing the RAN 121 in the future, or the like).

It will be appreciated that, although primarily presented herein with respect to examples for detecting and mitigating malicious activity of a single WED 110, detection and mitigation of malicious activity may be performed for detecting and mitigating malicious activity coordinated by multiple WEDs 110. For example, the WCN 120 may be configured to support detection and mitigation of malicious activity based on individual control of multiple RAN controllers to mitigate malicious activity, coordinated control of multiple RAN controllers to mitigate malicious activity, and the like. For example, the WCN 120 may be configured to support detection and mitigation of malicious activity based on use of a combination of anomaly engines configured to detect malicious activity and to determine the RAN-based identities of the WEDs 110 associated with the malicious activity based on interaction with the IC 124 (e.g., a CDR anomaly engine configured to detect malicious activity associated with WEDs 110 across multiple RAN controllers based on CDR data from the CN 125, a flow logic anomaly engine configured to detect malicious activity associated with WEDs 110 across multiple RAN controllers based on flow logic data from the CN 125, and the like). For example, the WCN 120 may be configured to support detection and mitigation of a coordinated security attack (e.g., a botnet attack or other type of coordinated attack) involving multiple WEDs 110 (e.g., the RAN controller 123 may support detection and mitigation of malicious activity by multiple WEDs 110 associated with multiple WADs 122 in the region controlled by the RAN controller 123, multiple RAN controllers controlling multiple regions may be controlled individually or in combination to support detection and mitigation of malicious activity by multiple WEDs 110 associated with multiple WADs 122 in the multiple regions controlled by the multiple RAN controllers, and so forth). It will be appreciated that detection and mitigation of malicious activity may be performed at successively broader layers of the network in order to detect wider ranging attacks which may be initiate by groups of WEDs 110 accessing the WCN 120 at various locations covered by various WADs 122, various RAN controllers 123, and the like.

It will be appreciated that, although primarily presented with respect to examples related to detection of malicious activity by malicious WEDs 110 that have already accessed the WCN 120 and mitigation of such malicious activity by releasing the malicious WEDs 110 from the WCN 120, WEDs 110 previously identified as being malicious also may be blocked from accessing the WCN 120. In one example, the RAN 121, upon receiving a request by a WED 110 to access the RAN 121, may determine whether the WED 110 was previously identified as being malicious toward the WCN 120 (e.g., based on previous detection of the WED 110 as being malicious toward the WCN 120). The determination as to whether the WED 110 was previously identified as being malicious may be performed by determining a RAN-based identifier of the WED 110 (e.g., the UE S1-AP ID of the WED 110) checking a blacklist of WEDs 110 previously identified as being malicious toward the WCN 120 for the RAN-based identifier of the WED 110. The RAN 121, based on a determination that the WED 110 was not previously identified as being malicious (e.g. the UE S1-AP ID of the WED 110 is not on the blacklist) then may be permitted to attach to the RAN 121. The RAN 121, based on a determination that the WED 110 was previously identified as being malicious (e.g. the UE S1-AP ID of the WED 110 is on the blacklist) may be blocked from attaching to the RAN 121. It will be appreciated that the functions performed by the RAN 121 for controlling access to the RAN 121 by WEDs 110 based on previous detection and mitigation of malicious activity may be performed by the WAD 122 (e.g., where the blacklist is maintained on the WAD 122), by the RAN controller 123 based on information from the WAD 122 (e.g., where the blacklist is maintained on the RAN controller 123 and the WAD 122 provides the RAN-based identifier of the WED 110 to the RAN controller 123 for checking the blacklist), or the like.

It will be appreciated that, although primarily presented with respect to examples related to detection of malicious activity by malicious WEDs 110 that have already accessed the WCN 120 and mitigation of such malicious activity by releasing the malicious WEDs 110 from the WCN 120 and examples for blocking WEDs 110 previously identified as being malicious from accessing the WCN 120, various combinations of such examples may be used to protect the WCN 120 from malicious activity of malicious WEDs 110.

In one example, protection of the WCN 120 from malicious activity of a WED 110 may include receiving a request by the WED 110 to access the RAN 121, determining, from the request by the WED 110 to access the RAN 121, a RAN-based identifier of the WED 110, and blocking the WED 110 from accessing the RAN 121 based on identification of the RAN-based identifier of the WED 110 in a blacklist of WEDs 110 which are not authorized to access the RAN 121, wherein the RAN-based identifier of the WED 110 was previously added to the blacklist of WEDs 110 which are not authorized to access the RAN 121 based on detection of malicious activity by the WED 110 within the WCN 120 (e.g., within the RAN 121 and/or the CN 125), identification of the RAN-based identifier of the WED 110 based on the detection of the malicious activity by the WED 110 within the WCN 120 (e.g., based on a mapping between a CN-based identifier of the WED 110 and the RAN-based identifier of the WED 110 where the malicious activity of the WED 110 is detected within the CN 125), and addition of the RAN-based identifier of the WED 110 to the blacklist of WEDs 110 which are not authorized to access the RAN 121.

In one example, protection of the WCN 120 from malicious activity of a WED 110 may include receiving a first request by the WED 110 to access the RAN 121, supporting communication of the WED 110 in the RAN 121 and the CN 125, identifying a RAN-based identifier of the WED 110 based on an indication that the WED 110 has engaged in malicious activity within the WCN 120, initiating, based on the RAN-based identifier of the WED 110, a mitigation action configured to cause the malicious WED 110 to be released from the RAN 121, adding the RAN-based identifier of the WED 110 to a blacklist of WEDs 110 which are not authorized to access the RAN 121, receiving a second request by the WED 110 to access the RAN 121, determining, from the second request by the WED 110 to access the RAN 121, a RAN-based identifier of the WED 110, and blocking the WED 110 from accessing the RAN 121 based on identification of the RAN-based identifier of the WED in the blacklist of WEDs 110 which are not authorized to access the RAN 121.

In one example, protection of the WCN 120 from malicious activity of a WED 110 may include receiving a request of a WED 110 the WCN 120 (e.g., a request of the WED 110 to access the RAN 121), determining, based on the request of the WED 110 to access the WCN 120, a RAN-based identifier of the WED 110, wherein the RAN-based identifier of the wireless device is configured to uniquely identify the WED within the RAN 121, determining, based on the RAN-based identifier of the WED 110 and based on a blacklist of WEDs 110 to be blocked from accessing the RAN 121, that the WED 110 is to be blocked from accessing the RAN 121, wherein the WED 110 was previously added to the blacklist of WEDs 110 to be blocked from accessing the RAN 121 based on a determination that the WED 110 engaged in malicious activity within the CN 125, identification of a CN-based identifier of the WED 110 based on the determination that the WED 110 engaged in malicious activity within the CN 125, identification of the RAN-based identifier of the WED 110 based on a mapping between the CN-based identifier of the WED 110 and the RAN-based identifier of the WED 110, and addition of the RAN-based identifier of the WED 110 to the blacklist of WEDs 110 to be blocked from accessing the RAN 121, and initiating, based on the determination that the WED 110 is to be blocked from accessing the RAN 121, a process for blocking the WED 110 from accessing the RAN 121 (e.g., a process for interrupting a RAN connection procedure, a process for terminating a UE attach procedure, and the like).

It will be appreciated that protection of the WCN 120 from malicious activity of a WED 110, based on a combination of releasing malicious WEDs 110 and blocking future access by malicious WEDs 110, may be performed in various other ways.

It will be appreciated that the system 100 has been simplified and, thus, that the system 100 may be implemented in a different form than that which is illustrated in FIG. 1. For example, the system 100 may be expanded by including additional elements, devices, networks, providers, and so forth, without altering the scope of the present disclosure. For example, the system 100 may be altered to omit various elements, substitute elements for other elements that perform the same or similar functions, combine elements that are illustrated as separate elements, and/or implement elements as functions that are spread across several devices that operate collectively as the respective elements, without altering the scope of the present disclosure. It will be appreciated that the system 100 may be modified in various other ways while still supporting detection and mitigation of malicious activity of malicious wireless devices. Therefore, these and various other modifications are all contemplated within the scope of the present disclosure.

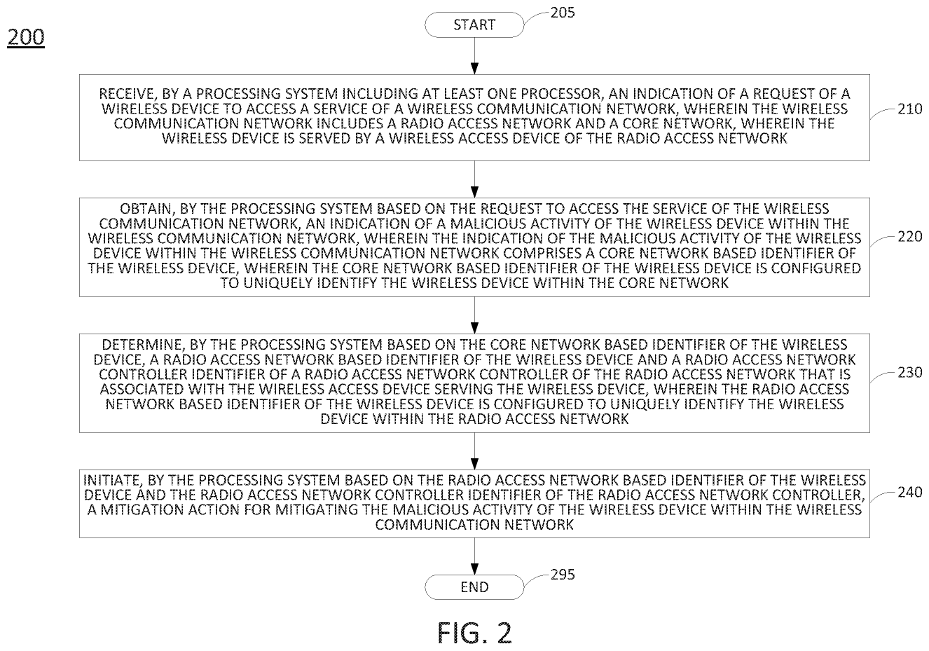

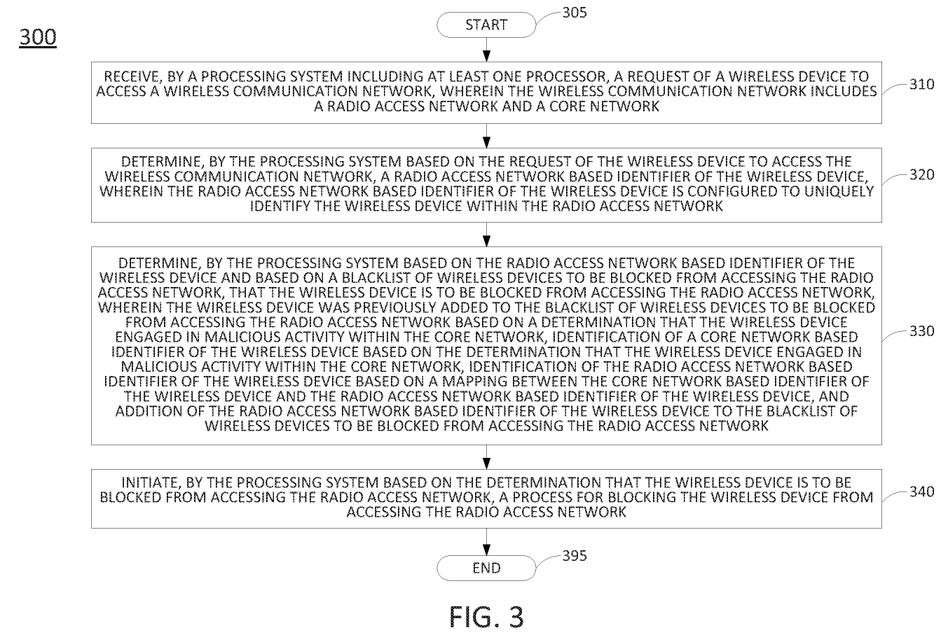

It is noted that various features discussed in conjunction with FIG. 1 may be further understood from the example methods of FIG. 2 and FIG. 3, which are described below.

FIG. 2 illustrates a flowchart of an example method for supporting detection and mitigation of a malicious activity of a malicious wireless device. In one example, the method 200 is performed by one or more components of the system 100 of FIG. 1 (e.g., one of the WADs 122, the RAN controller 123, the IC 124, the MAD 128, and so forth). In one example, the steps, functions, or operations of method 200 may be performed by a computing system 400 as described in connection with FIG. 4 below. For instance, the computing system 400 may represent any one or more components of the system 100 of FIG. 1 that is/are configured to perform the steps, functions, and/or operations of the method 200. Similarly, in one example, the steps, functions, and/or operations of method 200 may be performed by a processing system including one or more computing devices collectively configured to perform various steps, functions, and/or operations of the method 200. For instance, multiple instances of the computing system 400 may collectively function as a processing system.

As illustrated in FIG. 2, the method 200 begins in step 205 and proceeds to step 210. At step 210, the processing system may receive an indication of a request of a wireless device to access a service of a wireless communication network, wherein the wireless communication network includes a radio access network and a core network, wherein the wireless device is served by a wireless access device of the radio access network.

At step 220, the processing system may obtain, based on the request to access the service of the wireless communication network, an indication of a malicious activity of the wireless device within the wireless communication network, wherein the indication of the malicious activity of the wireless device within the wireless communication network includes a core network based identifier of the wireless device, wherein the core network based identifier of the wireless device is configured to uniquely identify the wireless device within the core network. In one example, the obtaining of the indication of the malicious activity of the wireless device within the wireless communication network includes detecting, by the processing system at an element of the core network, the malicious activity of the wireless device within the wireless communication network. In one example, the detecting of the malicious activity of the wireless device within the wireless communication network is based on analysis of at least one of a call detail record or a key performance indicator. In one example, the obtaining of the indication of the malicious activity of the wireless device within the wireless communication network includes receiving, by the processing system from an element of the radio access network or an element of the core network, the indication of the malicious activity of the wireless device within the wireless communication network.

At step 230, the processing system may determine, based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network. In one example, the determining of the radio access network based identifier and the radio access network controller identifier includes sending, by the processing system, a query including the core network based identifier of the wireless device and receiving, by the processing system, a response including the radio access network based identifier of the wireless device and the radio access network controller identifier. In one example, the radio access network based identifier of the wireless device and the radio access network controller identifier of the radio access network controller are determined based on a mapping of the core network based identifier of the wireless device to the radio access network based identifier of the wireless device, wherein the mapping of the core network based identifier of the wireless device to the radio access network based identifier of the wireless device is determined based on an attachment of the wireless device to the radio access network and a set of records of the core network. In one example, the core network based identifier includes a subscriber identifier. In one example, the subscriber identifier includes an international mobile subscriber identity (e.g., an IMSI). In one example, the radio access network based identifier includes a tuple including a wireless device identifier of the wireless device within the radio access network and a mobility management identifier of the wireless device within the radio access network. In one example, the wireless device identifier of the wireless device within the radio access network is assigned within the radio access network and the mobility management identifier of the wireless device within the radio access network is assigned within the core network. In one example, the wireless device identifier of the wireless device within the radio access network includes a user equipment s1 application protocol identifier (e.g., a User Equipment (UE) S1 Application Protocol (S1-AP) Identifier) and the mobility management identifier of the wireless device within the radio access network includes a mobility management entity s1 application protocol identifier (e.g., a Mobility Management Entity (MME) S1-AP Identifier).

At step 240, the processing system may initiate, based on the radio access network based identifier of the wireless device and the radio access network controller identifier of the radio access network controller, a mitigation action for mitigating the malicious activity of the wireless device within the wireless communication network. In one example, the initiating of the mitigation action includes sending, by the processing system toward the radio access network, a message indicative that the wireless device has been identified as malicious, wherein the message indicative that the wireless device has been identified as malicious includes the radio access network based identifier of the wireless device and the radio access network controller identifier of the radio access network controller. In one example, the initiating of the mitigation action includes sending, by the processing system toward the radio access network controller of the radio access network based on the radio access network controller identifier of the radio access network controller, a message indicative that the wireless device has been identified as malicious, wherein the message indicative that the wireless device has been identified as malicious includes the radio access network based identifier of the wireless device. In one example, the mitigation action is configured to cause the radio access network controller to at least one of initiate a process for causing the wireless device to be released from the radio access network and initiate a process for blocking the wireless device from accessing the radio access network. In one example, the mitigation action includes an action configured to cause the wireless device to be released from the radio access network. In one example, the mitigation action includes an action configured to cause the wireless device to be added to a blacklist of wireless devices which are to be blocked from accessing the radio access network. Following step 240, the method 200 proceeds to step 295 where the method 200 ends.

It will be appreciated that the method 200 may be expanded to include additional steps, or may be modified to replace steps with different steps, to combine steps, to omit steps, to perform steps in a different order, and so forth. It will be appreciated that these and other modifications are all contemplated within the scope of the present disclosure.

It will be appreciated, although not expressly specified above, one or more steps of the method 200 may include storing, displaying, and/or outputting steps as required for a particular application. In other words, any data, records, fields, and/or intermediate results discussed in the method can be stored, displayed, and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Thus, the use of the term “optional step” is intended to reflect different variations of a particular illustrative example and is not intended to indicate that steps not labelled as optional steps to be deemed to be essential steps. Furthermore, operations, steps, or blocks of the above described method(s) can be combined, separated, and/or performed in a different order from that described above, without departing from the examples of the present disclosure.

FIG. 3 illustrates a flowchart of an example method for supporting blocking of a wireless device previously identified as a malicious wireless device. In one example, the method 300 is performed by one or more components of the system 100 of FIG. 1 (e.g., one of the WADs 122, the RAN controller 123, the IC 124, the MAD 128, and so forth). In one example, various steps, functions, or operations of method 300 may be performed by one or more computing systems similar to computing system 400 as described in connection with FIG. 4 below. For instance, the computing system 400 may represent any one or more components of the system 100 of FIG. 1 that is/are configured to perform steps, functions, and/or operations of the method 300. Similarly, in one example, steps, functions, and/or operations of method 300 may be performed by a processing system including one or more computing devices collectively configured to perform various steps, functions, and/or operations of the method 300. For instance, multiple instances of the computing system 400 may collectively function as a processing system.

As illustrated in FIG. 3, the method 300 begins in step 305 and proceeds to step 310.

At step 310, the processing system may receive a request of a wireless device to access a wireless communication network, wherein the wireless communication network includes a radio access network and a core network.

At step 320, the processing system may determine, based on the request of the wireless device to access the wireless communication network, a radio access network based identifier of the wireless device, wherein the radio access network based identifier of the wireless device is configured to uniquely identify the wireless device within the radio access network.

At step 330, the processing system may determine, based on the radio access network based identifier of the wireless device and based on a blacklist of wireless devices to be blocked from accessing the radio access network, that the wireless device is to be blocked from accessing the radio access network, wherein the wireless device was previously added to the blacklist of wireless devices to be blocked from accessing the radio access network based on a determination that the wireless device engaged in malicious activity within the core network, identification of a core network based identifier of the wireless device based on the determination that the wireless device engaged in malicious activity within the core network, identification of the radio access network based identifier of the wireless device based on a mapping between the core network based identifier of the wireless device and the radio access network based identifier of the wireless device, and addition of the radio access network based identifier of the wireless device to the blacklist of wireless devices to be blocked from accessing the radio access network.

At step 340, the processing system may initiate, based on the determination that the wireless device is to be blocked from accessing the radio access network, a process for blocking the wireless device from accessing the radio access network. Following step 340, the method 300 proceeds to step 395 where the method 300 ends.

It will be appreciated that the method 300 may be expanded to include additional steps, or may be modified to replace steps with different steps, to combine steps, to omit steps, to perform steps in a different order, and so forth. It will be appreciated that these and other modifications are all contemplated within the scope of the present disclosure.

It will be appreciated, although not expressly specified above, one or more steps of the method 300 may include a storing, displaying, and/or outputting steps as required for a particular application. In other words, any data, records, fields, and/or intermediate results discussed in the method can be stored, displayed, and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Thus, the use of the term “optional step” is intended to reflect different variations of a particular illustrative example and is not intended to indicate that steps not labelled as optional steps to be deemed to be essential steps. Furthermore, operations, steps, or blocks of the above described method(s) can be combined, separated, and/or performed in a different order from that described above, without departing from the examples of the present disclosure.

It will be appreciated that various examples of the present disclosure for supporting detection and mitigation of malicious wireless devices may provide various advantages or potential advantages. For example, various examples of the present disclosure for supporting detection and mitigation of malicious wireless devices, by enabling blocking of malicious UEs in the RAN, may prevent malicious UEs from initiating DoS attacks against the CN (and, thus, obviate the need to build individual DoS protection mechanisms for each of the elements of the CN, obviate the need to monitor each individual element of the CN for DoS attacks or other types of attacks which may be initiated by malicious UEs, and so forth, each of which provides significant cost savings). For example, various examples of the present disclosure for supporting detection and mitigation of malicious wireless devices, by enabling blocking of malicious UEs in the RAN, may improve capacity (e.g., spectrum capacity, data communication capacity, and so forth) of the RAN (e.g., capacity that might otherwise be consumed by malicious UEs if such UEs were not blocked from the RAN) and, thus, improve the experience of legitimate UEs in the RAN. It will be appreciated that various examples of the present disclosure for supporting detection and mitigation of malicious wireless devices may provide various other advantages or potential advantages.

It will be appreciated that, as used herein, the terms “configure” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures, and the like, which may cause a processing system executing computer-readable instructions, code, and/or programs to function differently depending upon the values of the variables or other data structures that are provided. As referred to herein, a “processing system” may include a computing device including one or more processors or cores or multiple computing devices collectively configured to perform various steps, functions, and/or operations as discussed herein.

FIG. 4 depicts a high-level block diagram of a computing system 400 (e.g., a computing device or processing system) specifically programmed to perform the functions described herein. For example, any one or more components or devices illustrated in FIG. 1, or described in connection with the method 200 of FIG. 2 or the method 300 of FIG. 3 may be implemented as the computing system 400. As depicted in FIG. 4, the computing system 400 includes a hardware processor element 402 (e.g., including one or more hardware processors, which may include one or more microprocessor(s), one or more central processing units (CPUs), and the like, where the hardware processor element 402 may also represent one example of a “processing system” as referred to herein), a memory 404 (e.g., random access memory (RAM), read only memory (ROM), a disk drive, an optical drive, a magnetic drive, a Universal Serial Bus (USB) drive, and the like), a module 405 for supporting detection and mitigation of malicious wireless devices, and various input/output devices 406 (e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It will be appreciated that, although one hardware processor element 402 is shown, the computing system 400 may employ a plurality of hardware processor elements. Furthermore, although one computing device is shown in FIG. 4, if the methods as discussed above are implemented in a distributed or parallel manner for a particular illustrative example, e.g., the steps of the above methods or the entire methods are implemented across multiple or parallel computing devices, then the computing system 400 of FIG. 4 may represent each of those multiple or parallel computing devices. Furthermore, one or more hardware processor elements 402 can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It will be appreciated that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the module 405 for supporting detection and mitigation of malicious wireless devices (e.g., a software program including computer-executable instructions) can be loaded into memory 404 and executed by hardware processor element 402 to implement the steps, functions or operations as discussed above in connection with the example method 200 of FIG. 2 or the example method 300 of FIG. 3. Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The hardware processor element 402 executing the computer-readable instructions relating to the above described method(s) can be perceived as a programmed processor or a specialized processor. As such, the module 405 for supporting detection and mitigation of malicious wireless devices (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may include a physical device, a hardware device, or a device that is discernible by the touch. More specifically, the computer-readable storage device or medium may include any physical devices that provide the ability to store information such as instructions and/or data to be accessed by a processor or a computing device such as a computer or an application server.

While various embodiments have been described above, it should be understood that they have been presented by way of example and not limitation. Thus, the breadth and scope of a preferred embodiment should not be limited by any of the above-described example embodiments, but should be defined in accordance with the following claims and their equivalents.

What is claimed is:

1. A method comprising:
receiving, by a processing system including at least one processor, an indication of a request of a wireless device to access a service of a wireless communication network, wherein the wireless communication network includes a radio access network and a core network, wherein the wireless device is served by a wireless access device of the radio access network;
obtaining, by the processing system based on the request to access the service of the wireless communication network, an indication of a malicious activity of the wireless device within the wireless communication network, wherein the indication of the malicious activity of the wireless device within the wireless communication network comprises a core network based identifier of the wireless device, wherein the core network based identifier of the wireless device is configured to uniquely identify the wireless device within the core network;
determining, by the processing system based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network; and
initiating, by the processing system based on the radio access network based identifier of the wireless device and the radio access network controller identifier of the radio access network controller, a mitigation action for mitigating the malicious activity of the wireless device within the wireless communication network.

2. The method of claim 1, wherein the obtaining of the indication of the malicious activity of the wireless device within the wireless communication network comprises:
detecting, by the processing system at an element of the core network, the malicious activity of the wireless device within the wireless communication network.

3. The method of claim 2, wherein the detecting of the malicious activity of the wireless device within the wireless communication network is based on an analysis of at least one of a call detail record or a key performance indicator.

4. The method of claim 1, wherein the obtaining of the indication of the malicious activity of the wireless device within the wireless communication network comprises:
receiving, by the processing system from an element of the radio access network or an element of the core network, the indication of the malicious activity of the wireless device within the wireless communication network.

5. The method of claim 1, wherein the determining of the radio access network based identifier and the radio access network controller identifier comprises:
sending, by the processing system, a query including the core network based identifier of the wireless device; and
receiving, by the processing system, a response including the radio access network based identifier of the wireless device and the radio access network controller identifier.

6. The method of claim 1, wherein the radio access network based identifier of the wireless device and the radio access network controller identifier of the radio access network controller are determined based on a mapping of the core network based identifier of the wireless device to the radio access network based identifier of the wireless device, wherein the mapping of the core network based identifier of the wireless device to the radio access network based identifier of the wireless device is determined based on an attachment of the wireless device to the radio access network and a set of records of the core network.

7. The method of claim 1, wherein the core network based identifier comprises a subscriber identifier.

8. The method of claim 7, wherein the subscriber identifier comprises an international mobile subscriber identity.

9. The method of claim 1, wherein the radio access network based identifier comprises a tuple including a wireless device identifier of the wireless device within the radio access network and a mobility management identifier of the wireless device within the radio access network.

10. The method of claim 9, wherein the wireless device identifier of the wireless device within the radio access network is assigned within the radio access network and the mobility management identifier of the wireless device within the radio access network is assigned within the core network.

11. The method of claim 9, wherein the wireless device identifier of the wireless device within the radio access network comprises a user equipment s1 application protocol identifier and the mobility management identifier of the wireless device within the radio access network comprises a mobility management entity s1 application protocol identifier.

12. The method of claim 1, wherein the initiating of the mitigation action comprises:
sending, by the processing system toward the radio access network, a message indicative that the wireless device has been identified as malicious, wherein the message indicative that the wireless device has been identified as malicious includes the radio access network based identifier of the wireless device and the radio access network controller identifier of the radio access network controller.

13. The method of claim 1, wherein the initiating of the mitigation action comprises:
sending, by the processing system toward the radio access network controller of the radio access network based on the radio access network controller identifier of the radio access network controller, a message indicative that the wireless device has been identified as malicious, wherein the message indicative that the wireless device has been identified as malicious includes the radio access network based identifier of the wireless device.

14. The method of claim 13, wherein the mitigation action is configured to cause the radio access network controller to at least one of: initiate a process for causing the wireless device to be released from the radio access network and initiate a process for blocking the wireless device from accessing the radio access network.

15. The method of claim 1, wherein the mitigation action comprises an action configured to cause the wireless device to be released from the radio access network.

16. The method of claim 1, wherein the mitigation action comprises an action configured to cause the wireless device to be added to a blacklist of wireless devices which are to be blocked from accessing the radio access network.

17. The method of claim 1, further comprising:
receiving, by the processing system, a request of the wireless device to access the radio access network;
determining, by the processing system based on a blacklist of wireless devices to be blocked from accessing the radio access network, that the wireless device is not permitted to access the radio access network, wherein the wireless device was previously added to the blacklist of wireless devices to be blocked from accessing the radio access network based on the mitigation action for mitigating the malicious activity of the wireless device; and
initiating, by the processing system based on the request of the wireless device to access the radio access network and based on the determination that the wireless device is not permitted to access the radio access network, a process for blocking the wireless device from accessing the radio access network.

18. The method of claim 17, wherein the process for blocking the wireless device from accessing the radio access network comprises a process for interrupting a radio access network connection procedure.

19. An apparatus comprising:
a processing system including at least one processor; and
a computer-readable medium storing instructions which, when executed by the processing system, cause the processing system to perform operations, the operations comprising:
receiving an indication of a request of a wireless device to access a service of a wireless communication network, wherein the wireless communication network includes a radio access network and a core network, wherein the wireless device is served by a wireless access device of the radio access network;
obtaining, based on the request to access the service of the wireless communication network, an indication of a malicious activity of the wireless device within the wireless communication network, wherein the indication of the malicious activity of the wireless device within the wireless communication network comprises a core network based identifier of the wireless device, wherein the core network based identifier of the wireless device is configured to uniquely identify the wireless device within the core network;
determining, based on the core network based identifier of the wireless device, a radio access network based identifier of the wireless device and a radio access network controller identifier of a radio access network controller of the radio access network that is associated with the wireless access device serving the wireless device, wherein the radio access network based identifier of the wireless device is configured to uniquely identify the wireless device within the radio access network; and
initiating, based on the radio access network based identifier of the wireless device and the radio access network controller identifier of the radio access network controller, a mitigation action for mitigating the malicious activity of the wireless device within the wireless communication network.

20. A method comprising:
receiving, by a processing system including at least one processor, a request of a wireless device to access a wireless communication network, wherein the wireless communication network includes a radio access network and a core network;
determining, by the processing system based on the request of the wireless device to access the wireless communication network, a radio access network based identifier of the wireless device, wherein the radio access network based identifier of the wireless device is configured to uniquely identify the wireless device within the radio access network;
determining, by the processing system based on the radio access network based identifier of the wireless device and based on a blacklist of wireless devices to be blocked from accessing the radio access network, that the wireless device is to be blocked from accessing the radio access network, wherein the wireless device was previously added to the blacklist of wireless devices to be blocked from accessing the radio access network based on a determination that the wireless device engaged in malicious activity within the core network, identification of a core network based identifier of the wireless device based on the determination that the wireless device engaged in malicious activity within the core network, identification of the radio access network based identifier of the wireless device based on a mapping between the core network based identifier of the wireless device and the radio access network based identifier of the wireless device, and addition of the radio access network based identifier of the wireless device to the blacklist of wireless devices to be blocked from accessing the radio access network; and
initiating, by the processing system based on the determination that the wireless device is to be blocked from accessing the radio access network, a process for blocking the wireless device from accessing the radio access network.
